(19) United States
(12) Patent Application Publication
(10) Pub. No.: US 2009/0196138 A1
(43) Pub. Date: Aug. 6, 2009

(54) INFORMATION RECORDING APPARATUS AND CONTROL METHOD THEREOF

(75) Inventors: Nobuaki Kaji, Yokohama-shi (JP); Kazuo Watabe, Yokohama-shi (JP); Takashi Usui, Yokohama-shi (JP); Keiichiro Yusu, Yokohama-shi (JP); Chosaku Noda, Yokohama-shi (JP); Kazuto Kuroda, Yokohama-shi (JP); Masahiro Saito, Yokohama-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/351,226

(22) Filed: Jan. 9, 2009

(30) Foreign Application Priority Data
Jan. 31, 2008 (JP) 2008-021413

(51) Int. Cl. G11B 7/00

(52) U.S. Cl. 369/59.11; 369/116; G9B/7

(57) ABSTRACT

According to one embodiment, in one embodiment of the invention, a laser drive circuit is provided with a first current source, a second drive current source, and a third current source. The control section selectively obtains a plurality of laser light use mode of controlling the from first to third current sources to use pulse laser light accompanying relaxation oscillation, and a complex laser light use mode of using laser light where laser pulses are combined, whose starting end has an abrupt impulse change portion caused by relaxation oscillation and whose intermediate section is a flat portion with a fixed intensity.

### CROSS-REFERENCE TO RELATED APPLICATIONS

This application is based upon and claims the benefit of priority from Japanese Patent Application No. 2008-021413, filed Jan. 31, 2008, the entire contents of which are incorporated herein by reference.

### BACKGROUND

1. Field

One embodiment of the present invention relates to an information recording apparatus and a control method thereof, and in particular to an apparatus and a method for recording information on a recording medium using subnanosecond pulse laser light.

2. Description of the Related Art

As a recording medium suitable for recording, reproducing and erasing (repetitive recording) of information, optical disks are widely used. Incidentally, optical disks can be classified to the CD standard and DVD (digital versatile disk) standard according to recording capacity. Especially, for recording video and audio (music data), the DVD standard and HD DVD and BD (Blu-ray disk) standards obtained by further developing the DVD standard are widely used in view of their recording capacities.

As a recording method used in such abovementioned optical disks, a method for recording information with further high density utilizing an abrupt pulse whose recording pulse length is smaller than 1 ns (nanosecond) has been developed. The recording method is called “a subnanosecond pulse recording method” or “a recording method utilizing relaxation oscillation”, for example.

Patent Document 1 (Jpn. Pat. Appln. KOKAI Publication No. 2002-123963) discloses an optical disk recording apparatus/semiconductor laser driving method using relaxation oscillation. Incidentally, Patent Document 1 describes that, when laser light for recording is output, a current injected into a semiconductor laser device is lowered, and the cycle is in a range from about 2 GHz and 4 GHz.

In the optical disk recording apparatus/semiconductor laser driving method described in Patent Document 1, it is shown to utilize relaxation oscillation in order to improve the rising and falling characteristics of laser light for recording. However, (1) Patent Document 1 does not describe that a heat-sensitive recording layer on a recording track is thermally reacted by laser light so that marks having various lengths corresponding to information are formed, a relationship with pulse laser light accompanying relaxation oscillation, and means for achieving low energy consumption; (2) Patent Document 1 does not describe an effective drive circuit or drive method for obtaining pulse laser light accompanying the relaxation oscillation.

### BRIEF DESCRIPTION OF THE SEVERAL VIEWS OF THE DRAWINGS

A general architecture that implements the various features of the invention will now be described with reference to the drawings. The drawings and the associated description are provided to illustrate embodiments of the invention and not to limit the scope of the invention.

FIG. 1 is a configuration explanatory diagram of a recording apparatus to which the present invention is applied;

FIG. 2 is a diagram showing details of a semiconductor laser drive circuit shown in FIG. 1;

FIG. 3 is a diagram showing an output example of a current source in the drive circuit shown in FIG. 2;

FIG. 4 is an illustration diagram of waveforms and marks for explaining an operation example of an apparatus according to the present invention;

FIG. 5 is an illustration diagram showing a relationship between the drive current from the drive circuit and current flowing in a laser device;

FIG. 6 is a diagram showing a relationship between a pulse interval Ts shown in FIG. 4 and a peak power ratio (P2/P1);

FIG. 7 is a diagram showing a configuration example of a laser device;

FIGS. 8A to 8D are diagrams showing a relationship between a drive current supplied to a laser device and output pulse from the laser device in a comparison manner of the conventional art and the present invention;

FIG. 9 is a diagram showing one example of a measurement result of a relaxation oscillation waveform obtained by a semiconductor laser having a resonator length of 650 μm;

FIGS. 10A and 10B are diagrams for explaining an amorphous mark formed by a recording pulse according to a related art, and an amorphous mark formed by a mono-pulse, respectively;

FIG. 11 is a diagram for explaining one example of a temperature distribution on a recording track when recording is performed by a mono-pulse; and

FIG. 12 is a diagram for explaining one example of a temperature distribution on a recording track when recording is performed according to a recording pulse according to the related art.

### DETAILED DESCRIPTION

Various embodiments according to the invention will be described hereinafter with reference to the accompanying drawings.

An object of the embodiments is to provide an information recording apparatus where, when pulse laser light falling in the subnanosecond class generated accompanying relaxation oscillation is used, a plurality of mono-pulses and a complex pulse are selectively used so that a stable mark with excellent quality is obtained, and a control method of the information recording apparatus.

According to one aspect of the present invention, there is an apparatus including a laser drive circuit supplying a drive current to a laser device and a control section controlling the drive current output from the laser drive circuit according to a write strategy, wherein recording is performed using laser light obtained from relaxation oscillation of the laser device.

According to another aspect, there is provided an apparatus including a laser drive circuit supplying a drive current to a laser device and a control section controlling the drive current output from the laser drive circuit according to a write strategy, wherein, the laser drive circuit includes a plurality of current sources and is configured to synthesize outputs of a plurality of current sources to perform outputting, and the control section is provided with means for controlling the plurality of current sources to selectively control a first drive current for forming a first mark and a second drive current for forming a second mark, the first drive current which can generates a plurality of laser lights under a situation of relaxation oscillation, the second drive current which can generates a laser light where laser pulses are combined, whose starting end has an abrupt impulse change portion caused by relaxation oscillation and whose intermediate section configures a flat portion with a fixed intensity.

According to the abovementioned means, it is able to form stable and various length marks which includes from a short length mark to a long length mark. By using both a plurality of laser lights use mode according to the first drive current, and the complex laser light use mode according to the second drive current, the overall energy output can be suppressed. Since the influence of temperature on peripheral parts can be reduced by this effect, aberrations of an optical element occurring due to thermal changes can be suppressed, so that the recording quality of a mark can be prevented from deteriorating.

Next, embodiments of the invention will be explained in detail below with reference to the drawings.

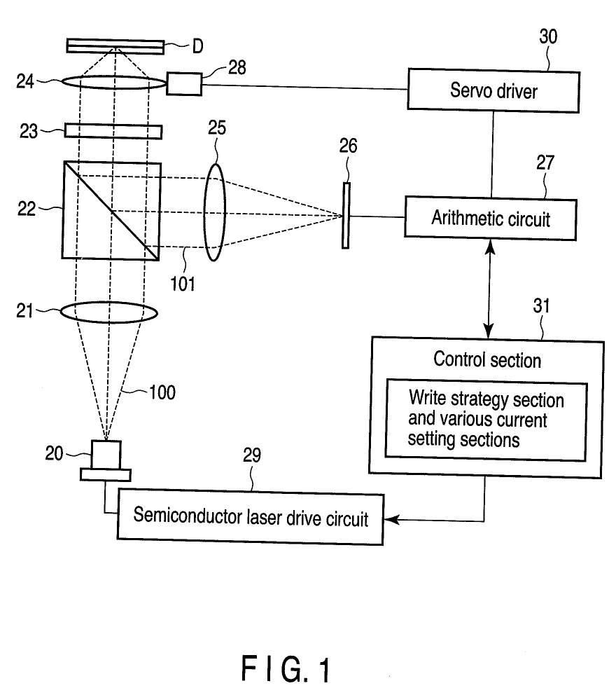

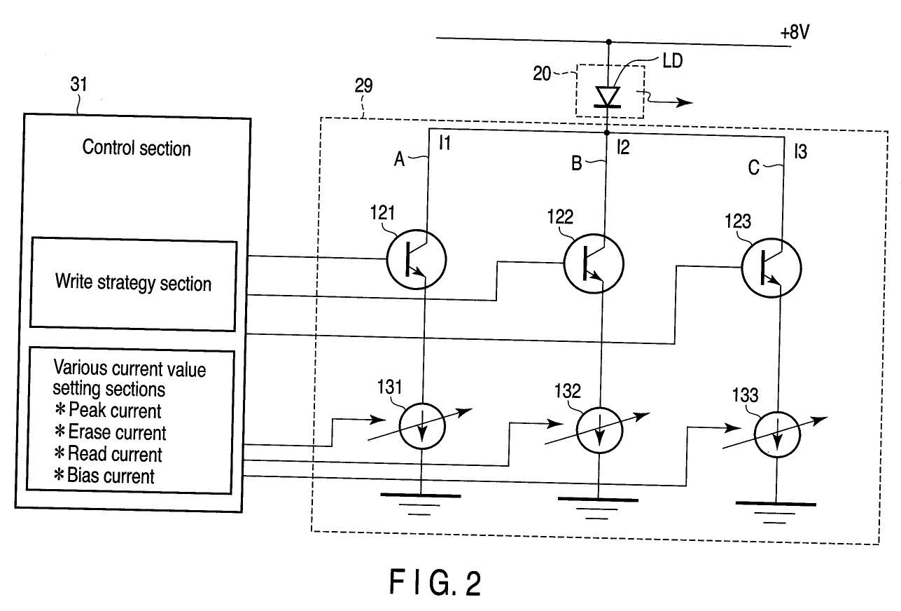

FIG. 1 shows one example of a configuration of an information recording apparatus (an optical disk apparatus) to which an embodiment of the invention can be applied. FIG. 2 is a block diagram showing a configuration of a semiconductor laser drive circuit 29 in the information recording apparatus (the optical disk apparatus).

As a light source, a semiconductor laser light source 20 for a short wavelength is used. A wavelength of light emitted from the light source 20 falls in a violet wavelength band in a range from 400 nm to 410 nm, for example.

Emitted light 100 from the semiconductor laser light source 20 is collimated to parallel light by a collimating lens 21 to pass through a polarization beam splitter 22 and a λ/4 plate 23. The light enters an objective lens 24. Thereafter, the light passes through a protective layer on an optical disk D to be focused on a target information recording layer. After reflected light 101 from the information recording layer on the optical disk D passes through the protective layer on the optical disk D and passes through the objective lens 24 and the λ/4 plate 23 to be reflected by the polarization beam splitter 22, it passes through the condenser lens 25 to enter a photodetector 26.

A light receiving portion of the photodetector 26 is generally sectioned to a plurality of receiving portions, where currents corresponding to light intensities are output from the respective receiving portions. After the output currents are converted to voltages by an I/V amplifier (not shown), they are processed to an HF signal for reproducing user data information, a focus error signal and a track error signal for controlling a position of a beam spot from the light source on the optical disk D, or the like by an arithmetic circuit 27. The arithmetic circuit 27 is controlled by a control section 31. The control section 31 includes a write strategy section, and various current setting sections.

The objective lens 24 can be driven in a focus control direction, i.e., up and down directions, and in a tracking control direction, i.e., a disk-radial direction, by an actuator 28, and it is controlled so as to follow an information track on the optical disk D by a servo driver 30. The optical disk D is a record-type disk on which information can be written, and information is written on the optical disk D by emitted light 100 from the semiconductor laser light source 20. In the semiconductor laser light source 20, a light amount of the emitted light 100 can be controlled by the semiconductor laser drive circuit 29.

At an information recording time to the optical disk D, the semiconductor laser drive circuit 29 is controlled by the control section 31 such that current flows in the semiconductor laser 20 according to information to be recorded on the optical disk D. Relaxation oscillation is caused by the semiconductor laser 20 at the information recording time to the optical disk D. Control is performed such that pulse laser emitted from the semiconductor laser light source 20 accompanying the relaxation oscillation is condensed to the targeted information recording layer. The recording pulse at the information recording time to the optical disk D will be described in detail later.

FIG. 2 shows a configuration example of the semiconductor laser drive circuit 29. The anode of a laser diode LD outputting laser light is connected to a power source terminal supplied with +8V. The cathode of the laser diode LD is connected with respective collectors of switch transistors 121, 122 and 123 operating at a high speed. The switch transistors 121, 122 and 123 are turned ON to allow current flow when their base potentials are at high levels, while they are turned OFF to shut off currents when the base potentials are at low levels. The bases of the switch transistors 121, 122 and 123 are input with modulation control signals corresponding to a write strategy from the control section 31. The period of time of supply of drive current supplied to the laser diode LD is controlled according to the write strategy. Dive current values corresponding to the various periods of time are set in the following manner.

That is, variable current sources 131, 132 and 133 are connected between the respective emitters of the switch transistors 121, 122 and 123, and a ground potential. Current amounts of the variable current sources 131, 132 and 133 are controlled by control signals V1, V2 and V3 from the control section 31 to take current values corresponding to the control signals V1, V2 and V3. The first current, second current, and third current flowing in the respective variable current sources 131, 132 and 133 are synthesized to configure the drive current of the abovementioned light source 20.

Here, a rising time of only one of the plurality of current sources is made fast and rising times of the remaining current sources are made slow within the drive circuit 29.

That is, design is made such that a rising time of a line “A” extending through the transistor 121 and the current source 131 is made fastest and a rising time of a line “B” extending through the transistor 122 and the current source 132 is made faster, and a rising time of a line “C” extending through the transistor 123 and the current source 133 is made slowest.

Assuming that a period of time elapsing until the current flowing in the laser diode LD rises from 10% of the maximum value thereof to 90% thereof is defined as the rising time, for example, the rising time T1 of the line “A” is 100 ps, the rising time T2 of the line “B” is 500 ps, and the rising time T3 of line “C” is 600 ps. Thus, by optimizing an internal configuration of the drive circuit and a transmission line from the drive circuit to the laser diode LD such that an impedance of a specific transmission line becomes optimal, a rising time can be minimized as compared with setting rising times of a plurality of current sources to be the same. By making the rising time of a specific line “A” fast, relaxation oscillation with a large peak power can be obtained when relaxation oscillation is generated at the laser device LD using the line “A”.

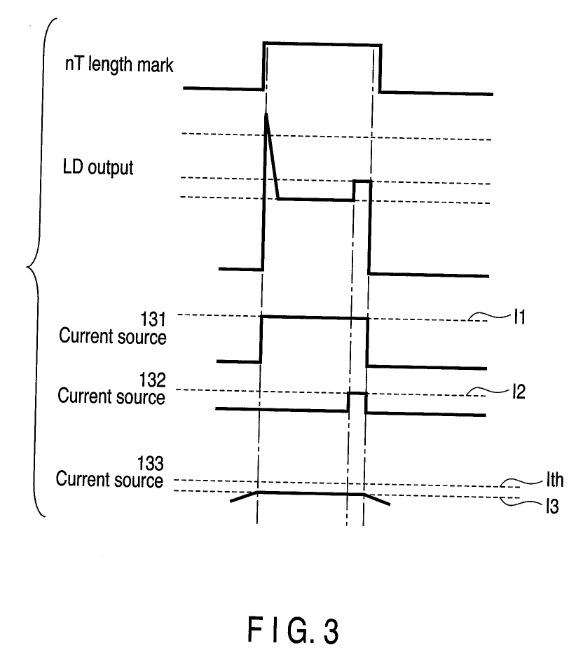

FIG. 3 shows an example of the laser intensity (LD output) of the laser device LD when a mark with a length nT is obtained and outputs of the current sources 131, 132 and 133 for obtaining the LD output. Regarding an output of the current source 131, a rising thereof is fast but a change frequency is low. Regarding an output of the current source 132, a change frequency is fast but rising may be slow. Regarding an output of the current source 133, the rising may be slow and a change frequency is low. A current output from current sources such as a diagram in FIG. 2 is caused to flow in the laser device LD using such a laser device drive section (LDD). The current flowing in the laser device LD at this time is equal to the sum of currents flowing according to driving of the respective current sources, namely, I1+I2+I3.

The current driving the laser device LD rapidly changes from a state that current I3, which is equal to or less than a threshold (Ith), is flowing, to large current I1. At this time, the laser device LD starts emission of light after a fixed time elapsing from current flowing into the laser device LD, and the intensity of laser oscillated for a while thereafter converges to a steady value while oscillation is being repeated. In above operation, the maximum laser intensity becomes larger than the intensity in a steady state.

In order to form a mark with an nT length, if the irradiation power in the steady state is employed, mark widths of a starting portion and of a terminating portion of the mark become small. This is because temperatures at the starting portion and the terminating portion for recording reached by laser irradiation are low since a temperature of a region surrounding a record region is lower than that at a mark center. Accordingly, it is necessary to raise laser intensities at the starting portion and the terminating portion. Therefore, a waveform of an laser output of the laser device LD takes a laser waveform where laser intensities at the starting position and the terminating position are large, i.e., a so-called “castle shape”, as shown in FIG. 3.

In the strategy using relaxation oscillation, the peak intensity of abrupt rising of the LD output such as shown in FIG. 3 can be changed by changing the magnitude of current I3 to be equal to or less than a threshold from the current source 133. The current source 133 can be set so as to reach peak intensity before the output current I1 from the current source 131 is output, so that a current source where a rising time is slow can be used as the current source 133.

Regarding the design of the drive circuit 29 for obtaining a castle-shaped laser light waveform accompanying relaxation oscillation at the abovementioned starting end, only the second current source is needed as the source of current to produce a high frequency. Therefore, a cost reduction can be achieved regarding circuit design.

Here, when pulse laser light falling in a subnanosecond class generated accompanying relaxation oscillation is used, switching can be performed between a plural times laser light use mode of outputting a plurality of pulse laser lights accompanying relaxation oscillation, and a complex laser light use mode of combining a pulse laser light accompanying relaxation oscillation and a fixed intensity laser light in order to form one mark in the apparatus and the method according to the present invention.

Incidentally, FIG. 3 shows especially important waveforms in the present invention comprehensibly, but the present invention is not limited to such a level and a period of time, and various waveforms can be produced in the drive circuit 29 shown in FIG. 2. The drive current for erasing, read current for mark information read, bias current and the like can be produced.

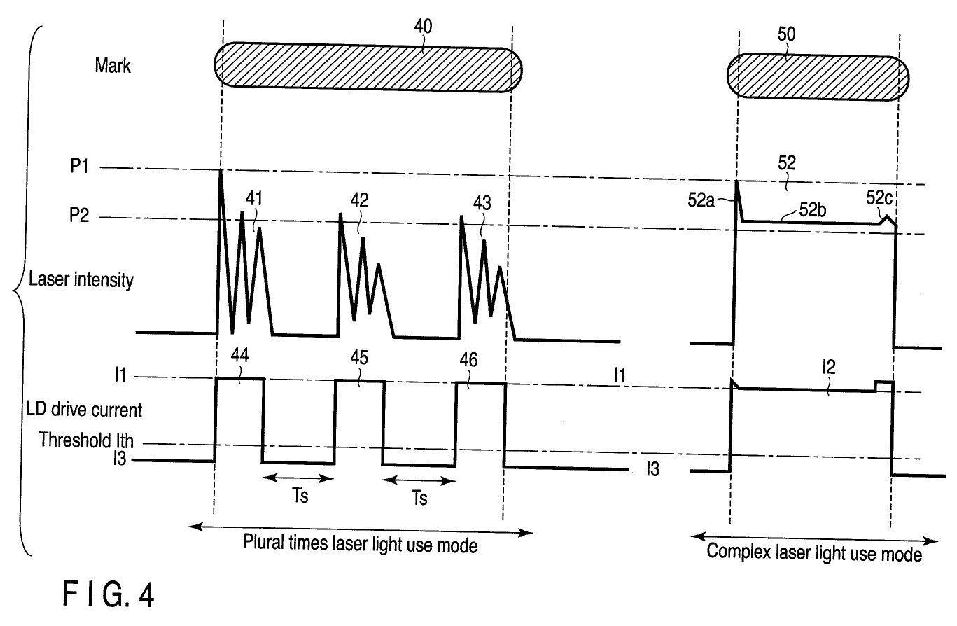

FIG. 4 shows examples of respective laser diode drive currents, laser lights (laser intensities), and marks to be formed in the plural times laser light use mode and in the complex laser light use mode.

In the plural times laser light use mode, a plurality of (for example, 3) pulse laser lights 41, 42 and 43 accompanying relaxation oscillation are output in order to form one mark 40. At this time, pulse-shaped drive currents 44, 45 and 46 are output. As the drive currents, outputs of the previous current sources 131 and 133 are mainly used.

On the other hand, in the complex laser light use mode, castle-type laser light 52 accompanying relaxation oscillation is output in order to form one mark 50. At this time, the castle-type laser light 52 has an abrupt changing portion 52a at a starting end thereof, and an intermediate portion thereof configures a flat portion 52b with a fixed intensity. A terminal end of the laser light 52 includes an emphasizing portion 52c emphasizing a fixed intensity. By use of the abovementioned processing, a mark with a symmetry regarding leading and trailing end shapes thereof in a track direction can be formed.

Next, cases of selection of the plurality of laser lights use mode or the complex laser light use mode will be explained.

<Case That Only Plural Times Laser Light Use Mode is Used>

In a recording strategy using laser light of mono-pulse accompanying relaxation oscillation, since the peak power is large and irradiation on a disk is performed with large power in a short time, diffusion of heat during irradiation of laser on a recording layer is small. Therefore, the recording energy can be reduced.

<Case that Complex Laser Light Use Mode>

On the other hand, in a recording strategy using castle-type laser light accompanying relaxation oscillation, when a long mark length is obtained, an abrupt impulse according to relaxation oscillation is present at a mark leading position, but a time where the laser device is being oscillated corresponding to an intermediate portion of the mark in a longitudinal direction thereof in a steady state becomes longer than that when laser light of a mono-pulse is obtained. As a result, the contribution energy of relaxation oscillation becomes relatively small, so that a large amount of energy is required as compared with the energy in recording using a mono-pulse train accompanying a plurality of relaxation oscillations.

When a large amount of energy is used, since an optical device such as an objective lens or a mirror in a pickup head thermally expands due to the temperature rise, and deforms, a spot diameter focused by the objective lens becomes large and a size of a mark to be recorded becomes large, thus the quality of a recorded mark degrades.

Therefore, when a mark with a mark length equal to or more than a certain length is formed, it is preferable that recording is performed by the plural times laser light use mode instead of recording performed by the complex laser light use mode.

As shown in FIG. 4, however, when a long mark 40 should be recorded by mono-pulses accompanying a plurality of relaxation oscillations, even if a plurality of mono-pulses is generated in a state that the drive current is kept constant in order to generate relaxation oscillation, the laser peak intensity P2 obtained from the second mono-pulse may become smaller than laser peak intensity P1 obtained from the first mono-pulse due to a time interval Ts between a mono-pulse and another mono-pulse.

This is because the magnitude of relaxation oscillation changes according to a value of current just before relaxation oscillation is generated even if a current value for driving relaxation oscillation is kept constant, which results in change of laser power.

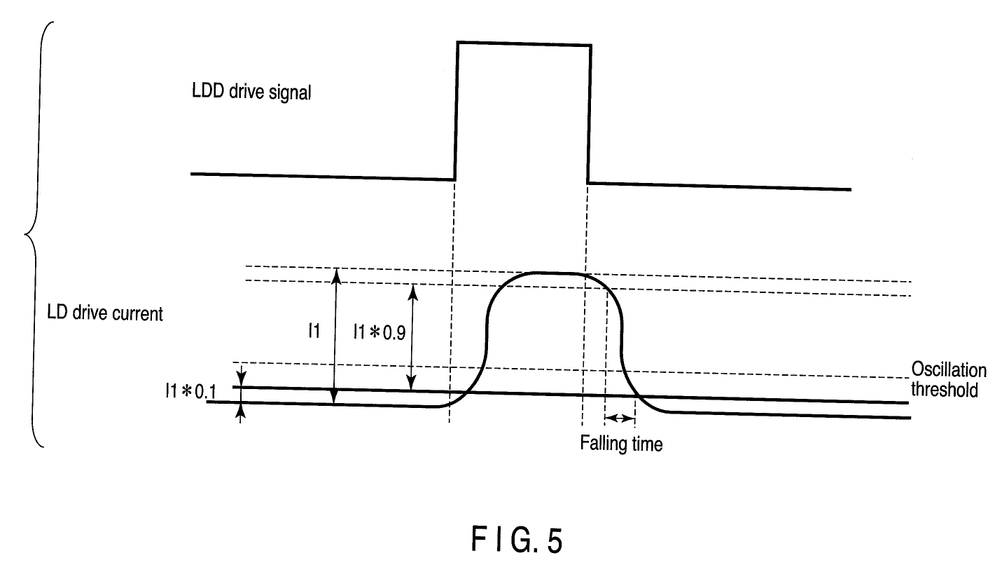

This is because a falling time of the laser device current is generated in the current applied to the laser device for generating relaxation oscillation due to impedances in the drive circuit, in the laser device, in a transmission line between the laser device and the drive circuit, and the like, as shown in FIG. 5.

In view of these circumstances, regarding the circuit of the present invention, assuming that a time where drive current flowing in the laser device lowered from 10% of the maximum value of the drive current to 90% thereof is defined as a falling time, the falling time was 500 ps.

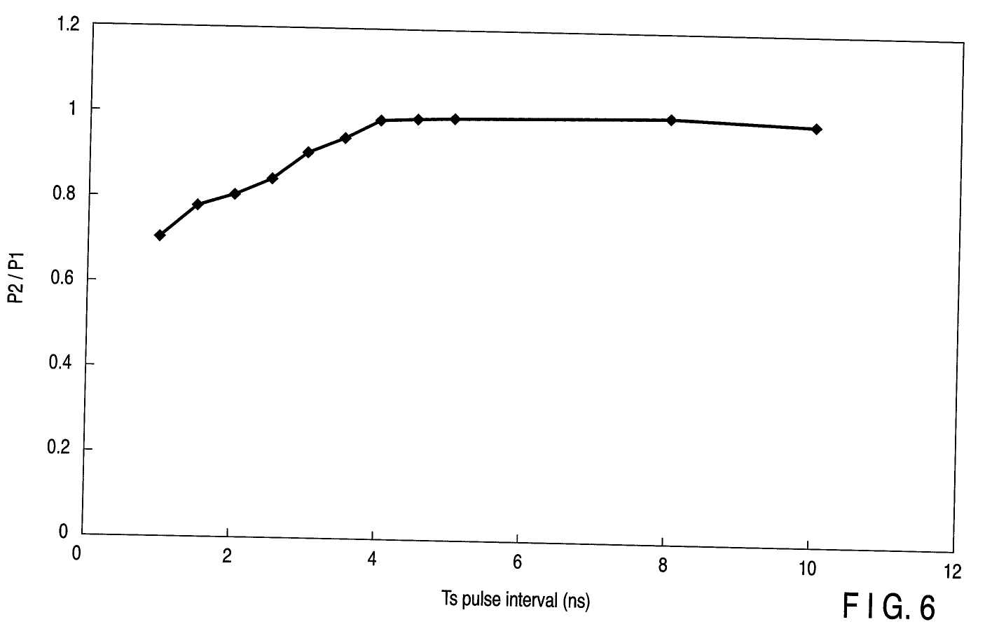

Here, FIG. 6 shows a relationship between a time of Ts (an interval between the mono-pulse and the mono-pulse shown in FIG. 4) and (P2/P1) (a ratio of the laser light peak power obtained from the first relaxation oscillation and the laser light peak power obtained from the second relaxation oscillation). From this, it is understood that, when the pulse interval Ts is small, the magnitude of power of the second laser becomes smaller than that of the first laser due to the presence of a leading pulse. However, it is understood that, when Ts is 4 ns or more, the magnitude of laser power of the second relaxation oscillation is hardly influenced by the first relaxation oscillation. That is, the magnitude of laser power of the second relaxation oscillation is almost as same as the magnitude of laser power of the first relaxation oscillation.

Incidentally, the pulse interval Ts also depends on a falling time of current of the laser device LD, and it is desirable that Ts is made longer according to the increase of the falling time.

In the example shown in FIG. 6, it is understood that, when the falling time of current of the laser device LD is 4 ns or more, the power of laser obtained from the next mono-pulse is not influenced by the previous mono-pulse.

It is known that the second relaxation oscillation becomes small according to the increase of the falling time of current in the laser device LD even if the pulse interval is kept constant. Therefore, considering the falling time of current in the laser device LD, it is understood that, when “falling time of current in laser device LD”+“pulse interval Ts” is 4.5 ns or more, the magnitude of laser power according to the second relaxation oscillation is hardly influenced by the first relaxation oscillation.

Here, even if the pulse interval Ts is 4 ns or less, it is thought that, considering the influence of the previous pulse, the pulse drive current of the next pulse laser is made large to compensate for such influence. However, it is understood that, when power of the next pulse laser is influenced by the previous pulse laser, the dispersion of peak intensity of the second pulse laser becomes large, in addition to the reduction of peak intensity of the second pulse laser. That is, even if pulses are oscillated under the same condition, variations among peak intensities of respective pulses become large. This causes unevenness of mark shapes of respective marks recorded using relaxation oscillation of laser, which results in deterioration of an error rate when data is reproduced after recorded.

For reasons mentioned above, it is undesirable to perform recording using a plurality of relaxation oscillations, when “falling time of current of laser device LD”+“pulse interval Ts” is smaller than 4.5 ns.

That is, when recording is performed using a plurality of relaxation oscillations, the power peak of laser light obtained from the second relaxation oscillation fluctuates due to the influence of the first mono-pulse, so the formation of a recorded mark becomes unstable.

Therefore, when the rotational speed of a disk increases and recording is performed at a high speed, such a case may occur that Ts becomes smaller than 4.5 ns, but a mark with a high quality can be recorded in such a case by performing switching of the recording strategy from “plural times laser light use mode” to “complex laser light use mode” at this time.

Even when recording is performed using the so-called castle-type recording waveform, a period of time of a flat portion is short, so that the heat energy is small, which removes the possibility of deformation, due to thermal expansion of an objective lens or a mirror in a pickup head.

As the above result, it is preferable that, when “falling time of current of laser device LD”+“pulse interval Ts” is equal to 4.5 ns or less, recording is performed using the relaxation oscillation+the castle-type recording waveform, and when “falling time of current of laser device LD”+“pulse interval Ts” is more than 4.5 ns, a plurality of laser pulse lights obtained from a plurality of mono-pulses accompanying relaxation oscillation is used.

However, when “falling time of current of laser device LD”+“pulse interval Ts” is smaller than 4.5 ns and the mark length is the shortest mark length (for example, 2T), laser pulse light configured by only one mono-pulse accompanying relaxation oscillation is satisfactory. In this case, only one mono-pulse is adopted.

Incidentally, the configuration of the laser drive circuit 29 has been explained above with reference to FIG. 2, but the laser drive circuit 29 is not limited to this configuration. The number of current sources and the number of paths for a switch transistor may be further increased such that the write strategy can be achieved effectively. Such a scheme that switching and setting of a drive current in response to a disk to be used can be performed is adopted. Further, such a configuration that another device is used instead of the laser device can be adopted.

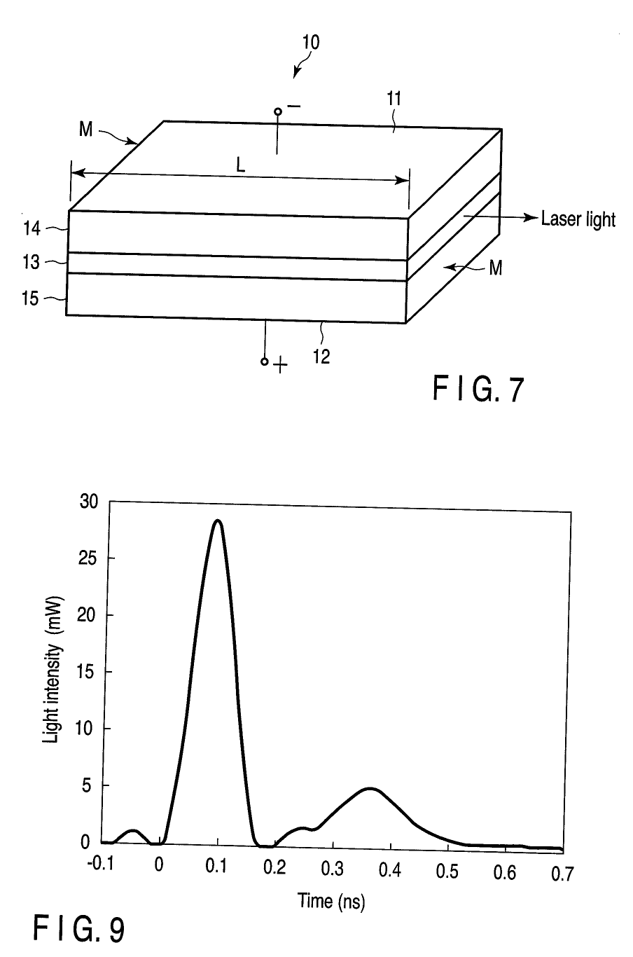

Next, the semiconductor chip section including the laser device LD used in the recording apparatus will be explained. FIG. 7 shows only the semiconductor chip section 10 serving as a light emitting body, where the semiconductor chip section 10 is generally fixed to a metal block serving as a heat sink and it further includes a base member, a cap with a glass window, and the like.

The semiconductor chip section 10 is a fine block having a thickness (a vertical direction on plane in FIG. 7) of 0.15 mm, a length (L in FIG. 7) of 0.5 mm, and a lateral width (in a depth direction in FIG. 7) of about 0.2 mm, as one example. The laser chip has an upper end electrode 11 and a lower end electrode 12, where the upper end electrode 11 is a minus (−) electrode and the lower end electrode 12 is a plus (+) electrode.

A central active layer 13 emits laser light and an upper side clad layer 14 and a lower side clad layer 15 are formed so as to sandwich the active layer 13 from above and beneath. The upper side clad layer 14 is an n-type clad layer including a lot of electrons and the lower side clad layer 15 is a p-type clad layer including a lot of holes.

A voltage is applied between the lower end electrode 12 and the upper end electrode 11 from the lower end electrode 12 to the upper end electrode 11 in a forward direction. That is, when a current is caused to flow from the lower end electrode 12 toward the upper end electrode 11, a lot of electrons and a lot of holes excited in the active layer 13 rejoin so that light corresponding to the energy lost at this time is discharged. Materials are selected such that refractive indexes of the upper side clad layer 14 and the lower side clad layer 15 are lower than an refractive index of the active layer 13 (the formers are lower than the latter by 5% as one example), where light generated in the active layer 13 configures a light wave advancing within the active layer 13 in left and right directions in FIG. 7 while it is reflected at a boundary with the upper side clad layer 14 and at a boundary with the lower side clad layer 15.

In FIG. 7, left and right end faces configure mirror faces M, and the active layer 13 itself forms a light resonator. The light wave which has advanced within the active layer 13 in left and right directions and has been reflected by the mirror faces at both the left and right end faces is amplified within the active layer 13 and it is finally discharged at the right end (and the left end) in FIG. 7 as laser light. At this time, the resonator length of the laser device LD is a length L in a horizontal direction in FIG. 7.

An emission waveform of the laser device LD is controlled by a drive current generated by the drive circuit 29. A recording pulse used for recording information on an optical disk will be explained as follows.

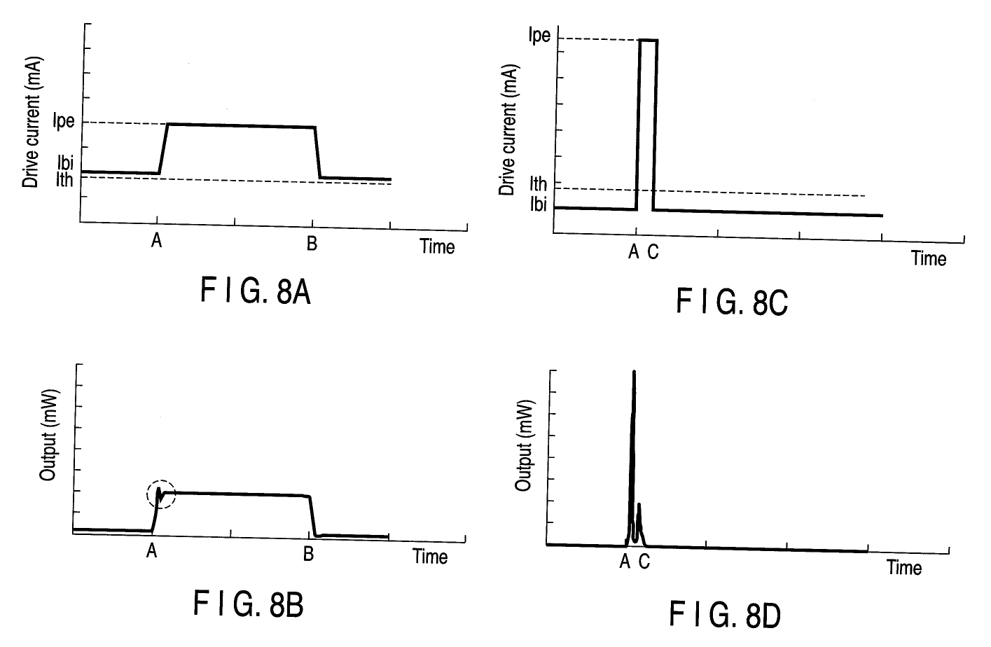

FIGS. 8A and 8B represent a conventional semiconductor laser drive current and a conventional semiconductor laser emission waveform, and FIGS. 8C and 8D represent a semiconductor laser drive current and a semiconductor laser emission waveform when a relaxation oscillation pulse is produced.

The drive current is controlled to two levels of bias current Ibi and peak current Ipe, as shown in FIG. 8A and 8C. Incidentally, there is such a case that the bias current is further subdivided to two levels or three levels to be controlled. Here, however, explanation is made using a case that the bias current Ibi and the peak current Ipe are each one level, for simplification of explanation.

In an ordinary recording pulse production, as shown in FIG. 8A, the drive circuit 29 first produces bias current Ibi set to a level slightly higher than a threshold current Ith at which the laser device LD starts laser oscillation to drive the laser device LD. Thereafter, peak current Ipe for obtaining the desired peak power is applied to the drive current 29 at a time A, and after application of the peak current Ipe is performed for a fixed time, lowering to the bias current Ibi is performed at a time B again. A change of emission light intensity from the laser device LD along time is shown in FIG. 8B.

As shown in FIGS. 8A and 8B, the emission light intensity is kept in an extremely low power where data recording on an optical disk is impossible by the time A, the laser device LD being driven by the bias current Ibi before the time A. Then the intensity is raised up to the recoding power since the laser device LD is driven by the peak current Ipe, and this power level is maintained until the drive current is lowered down to the bias current Ibi level at the time B. The emission light intensity lowers to a low power after the time B, again. Thus, the laser device LD is controlled such that recording pulses are emitted for a period of time from the time A to the time B.

To describe the light intensity in more detail, such an aspect can be known that, when the intensity is raised up to recording power at the time A, the intensity rises and lowers instantaneously until the recording power is stabilized to a steady recording power (a portion circled by a broken line FIG. 8B). This is due to relaxation oscillation of the laser device LD, and control is performed in an ordinary recording pulse production such that the relaxation oscillation becomes as small as possible.

Thus, the relaxation oscillation is a relaxation oscillation phenomenon that usually occurs in a semiconductor laser when the drive current rapidly rises from a certain level up to a fixed level exceeding the threshold current. The relaxation oscillation becomes smaller due to repetition of oscillations and it converges before long.

In the recording apparatus according to the embodiment, the relaxation oscillation is positively utilized for recording. When the relaxation oscillation is used as recording pulses, as shown in FIG. 8C, the drive circuit 29 first produces bias current Ibi set to a level lower than the threshold current Ith of the laser device LD to drive the laser device LD.

Thereafter, the drive current is abruptly raised up to the peak current Ipe with a rising time faster than an ordinary recording pulse production at the time A, and the drive current is lowered down to the bias current Ibi after a time shorter than that in the ordinary recording pulse production at the time C, again. The change of emission light intensity of the laser device LD with time is shown in FIG. 8D.

As shown in FIG. 8D, the laser device LD does not start laser oscillation by the time A, the laser device being driven with the bias current Ibi lower than the threshold current Ith before the time A, where the laser device LD only emits light in a negligible level as like a light emitting diode. Thereafter, relaxation oscillation is started according to abrupt current application at the time A, so that the emission light intensity rapidly rises. Thereafter, light emission caused by the relaxation oscillation is maintained by the time C at which the application current is returned back to the threshold current or less again. In this example, the time C is reached at a timing at which the second cycle pulse of the relaxation oscillation has been produced and then the recording pulse production is terminated.

Thus, a feature of the pulses generated by the relaxation oscillation lies in that the emission light intensity rises in a very short time, as compared with the ordinary recording pulse, and the emission light intensity lowers in a fixed cycle determined according to the structure of the semiconductor laser. Accordingly, by using pulses caused by the relaxation oscillation as recording pulses, it is made possible to obtain mono-pulses having short rising and falling times and having high peak intensity which cannot be obtained in the ordinary recording pulses.

As the commonly known relationship, the following relationship is found between the resonator length L and the relaxation oscillation cycle T.

T=k·{2nL/c} (1)

Here, k is a constant, n is a refractive index of an active layer of a semiconductor laser, and c is the speed of light (3.0×10⁸ (m/s)). Therefore, it is found that the resonator length L and the relaxation oscillation cycle t, and therefore, the relaxation oscillation pulse width are all in a proportional relationship.

From the above, when the relaxation oscillation pulse width should be elongated, the resonator length L can be extended, and when the relaxation oscillation pulse width should be reduced, the resonator length L can be shortened. That is, it can be said that the relaxation oscillation pulse width can be controlled by the resonator length L.

FIG. 9 shows a measurement result of a relaxation oscillation waveform obtained by a semiconductor laser having a resonator length L of 650 μm. It is found that the relaxation oscillation pulse width is about 81 ps at full width half maximum. Since it is found from the abovementioned equation (1) that the resonator length L and the relaxation oscillation pulse width are in a proportional relationship, the following relationship can be obtained as a conversion equation between the resonator length L of the semiconductor laser and the relaxation oscillation pulse width (FWHM) Wr obtained.

Wr (ps)=L (μm)/8.0 (μm/ps) (2)

Next, recording of data on an optical recording medium in the recording apparatus according to the present embodiment will be explained.

(Recording processing according to relaxation oscillation as viewed from formation of amorphous mark)

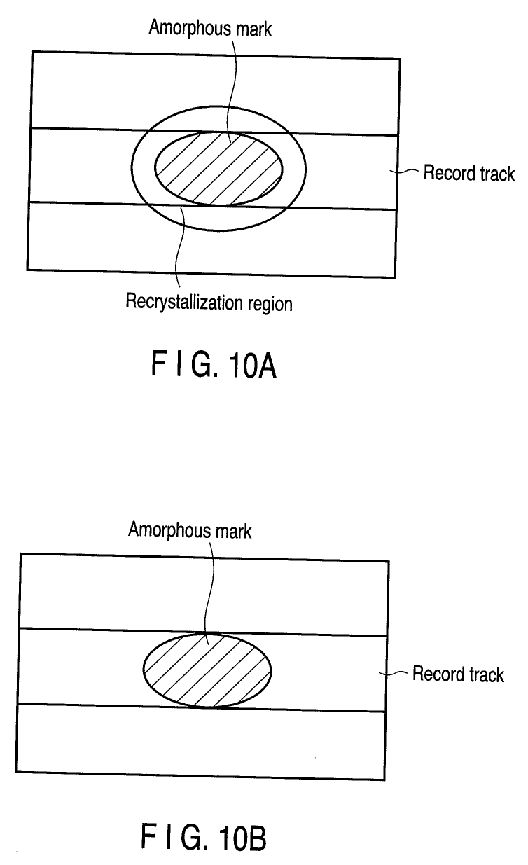

Next, a recording processing according to relaxation oscillation as viewed from formation of an amorphous mark will be explained in detail with reference to the drawings. FIG. 10A is a diagram for explaining an amorphous mark formed by a conventional recording pulse. FIG. 10B is a diagram for explaining an amorphous mark formed by a mono-pulse.

The recording means forming an amorphous mark on a region initialized to a crystalline state of a resist film. The amorphous mark is formed by melding a phase-change material and cooling the same rapidly just after the melting. Therefore, it is necessary to focus a relatively short pulse-shaped laser light with high power on a phase-change resist layer and raise a local temperature up to a temperature exceeding a melting point Tm of the phase-change material to cause local melting. Thereafter, when the recording pulse is interrupted, the melted local region is abruptly cooled, thus a solid amorphous mark is formed via the melting and cooling process.

On the other hand, a case that a recorded data bit is erased will be explained below. The erasing is performed by recrystallizing the amorphous mark. The crystallization is realized by local annealing. By focusing laser light on the recording layer to perform controlling to a level slightly lower than the recording power, the local temperature on the phase-change recording layer is raised up to the crystallization temperature Tg or higher ant it is kept at a temperature lower than the melting point Tm.

At this time, the amorphous mark can be phase-changed to a crystalline state by maintaining the local temperature in a range between the crystallization temperature Tg and the melting point Tm for a fixed period of time. Thus, erasing of the recorded mark can be made possible. Incidentally, a time to be maintained in the range between the crystallization temperature Tg and the melting point Tm, which is required for crystallization at this time is called “crystallization time”. When the data bit recorded is reproduced, the information recording layer is irradiated with DC laser light with such low power that the recording layer is not phase-changed, namely, a reproduction power.

When an amorphous mark formed by a conventional recording pulse is formed via the melting and rapid cooling process of the phase-change material, as described above, an annular region (recrystallization ring) of recrystallization occurs around a peripheral edge portion of the amorphous mark, as shown in FIG. 10A.

This annular region is a region which has been once melted at a peripheral edge portion of the amorphous mark, which is re-crystallized by maintaining a temperature region between the crystallization temperature Tg and the melding point Tm for at least the crystallization time in the cooling process. The annular region eventually serves to reduce a size of the amorphous mark (self-sharpening effect), but it may cause jitter (fluctuation) of a reproduction signal at the mark peripheral edge portion, thermal interference between the previous and the next marks on a track, and partial erase (cross erase) of a mark formed on an adjacent track.

On the other hand, an amorphous mark formed by a mono-pulse such as a relaxation oscillation pulse in the recording apparatus according to the embodiment hardly generates a recrystallization ring at the peripheral edge portion of the amorphous mark, as shown in FIG. 10B. This is because only a melted portion just after irradiation of laser light is formed in an amorphous mark by irradiating a phase-change layer with laser light with high power for a short time using a mono-pulse to melt the phase-change layer just after the laser light irradiation and terminating the irradiation before the melted region significantly spreads to a peripheral region thereof due to heat conduction.

Thus, such a merit can be obtained in an amorphous mark that jitter at the mark peripheral edge portion is reduced, and neither mark deformation nor edge shift due to thermal interference between the previous and next marks on a track, nor cross erase of a mark formed on an adjacent track occurs. This is because of a recrystallization ring does not occur.

Of course, since such a merit as a qualitative improvement of a recorded mark described above can be obtained in recording according to mono-pulse and a mark can be recorded in a short time, the recording according to mono-pulse is suitable for a high transmission rate recording.

The demand for high transmission rate along with large capacity is strong for optical disks, and Standard for double speed compared with the standard speed (linear speed: 6.61 m/s) has been already issued regarding HD DVD-R or DVD-RW. A higher multiplication speed, such as fourfold or eightfold is expected in the future.

In order to achieve a high transmission rate, it is necessary to record a recording mark at a high speed, namely, in a short time. In a phase-change type disk, this means recording an amorphous mark using a mono-pulse. In HD DVD, for example, a channel clock rate is 518.4 Mbps and a time corresponding to one channel bit is 1.929 ns at eightfold speed.

A pulse width required for mono-pulse recording in the recording apparatus according to the present embodiment is a pulse width such that a recrystallization ring does not occur at a formation time of an amorphous mark. A region where the recrystallization ring occurs at the formation time of an amorphous mark is a region which has been once melted at the amorphous peripheral edge portion, as described above, namely, a region whose temperature has exceeded the melting point of the phase-change material. At this time, only a region whose temperature has slightly exceeded the melting point is re-crystallized.

This is because a region whose temperature has been raised up to a temperature largely exceeding the melting point has a large gradient of temperature lowering and is cooled relatively abruptly so that it is made amorphous. As is understood from the well-known relationship between temperature gradient δT/δx and heat flow density q (W/m²), this is because heat flow from a high temperature region to a low temperature region increases according to increase of the temperature gradient. Here, K (W/m·K) is the thermal conductively and x is a distance in an interface having a temperature difference in a heat conduction direction (in a normal vector direction of an interface).

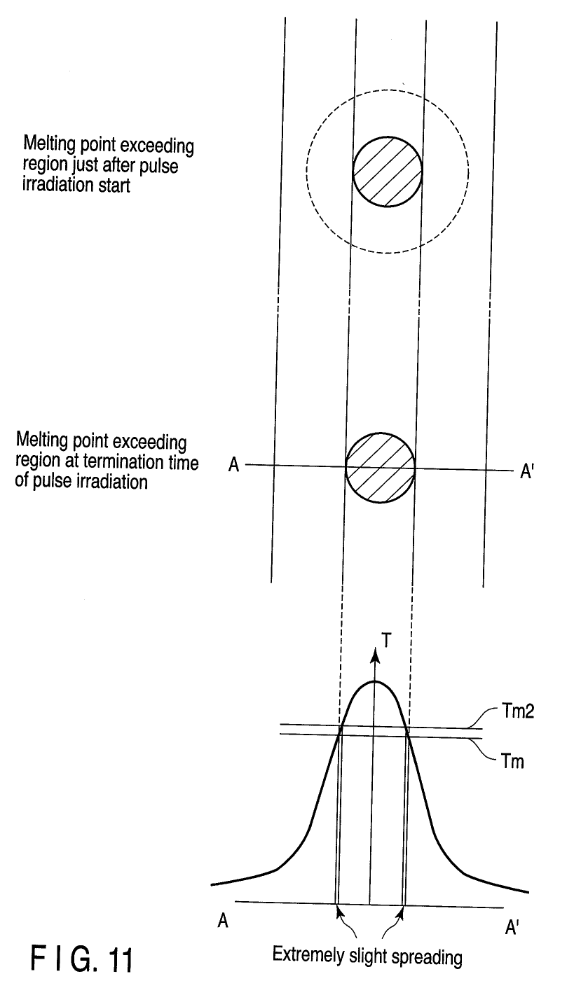

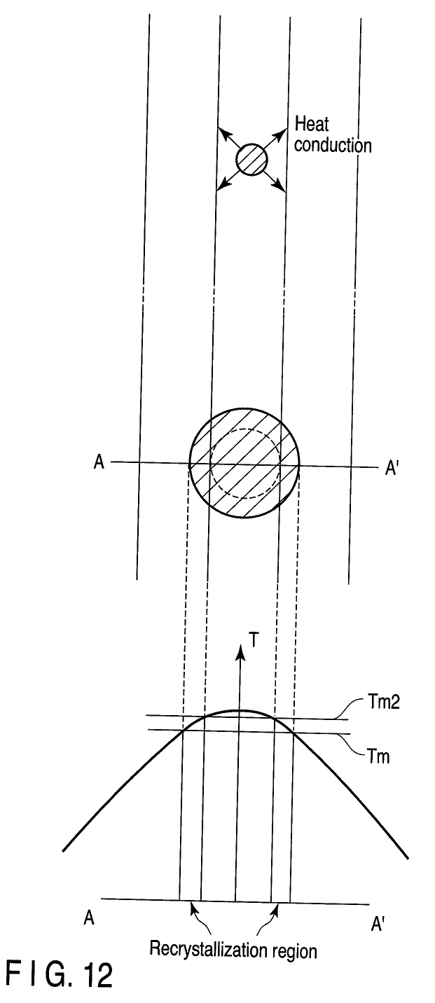

In case of mono-pulse recording, irradiation of laser light having high power is performed such that the temperature of a light spot central portion exceeds the melting point just after laser light irradiation. FIG. 11 and FIG. 12 are diagrams for explaining a temperature distribution on a record track, where upper stages of FIG. 11 and FIG. 12 represent melting point-exceeding regions on a track just after recording pulse irradiation, middle stages thereof represent melting point-exceeding regions on a track at a recording pulse termination time, and lower stages thereof represent temperature distributions in section A-A′ in the middle stages.

FIG. 11 represents a case of mono-pulse recording, while FIG. 12 represents a case of recording performed using a conventional recording pulse. Incidentally, a recording beam spot (a region represented by a broken line in FIG. 11) intrinsically moves in a vertical direction on FIG. 11 during pulse irradiation, but it is assumed for simplification of explanation that the recording beam spot does not move in this example.

In each of the conventional recording pulse and the mono-pulse, a region on the light spot center whose temperature exceeds the melting point in a period from just after pulse irradiation to termination of pulse irradiation expands due to heat conduction. In the case of the mono-pulse, however, since a pulse irradiation time is short, the region hardly expands.

In the case of mono-pulse recording, a temperature distribution in section including the light spot center at the termination time of pulse irradiation forms a Gaussian distribution approximately equal to a distribution shape just after light beam irradiation, and has an abrupt temperature gradient near a boundary between a temperature higher than the melting point and a temperature lower than the melting point. Therefore, a region which is re-crystallized, namely, a region in a range slightly exceeding the melting point (a region having a temperature between the melting point Tm and a temperature Tm2) hardly spreads in a plane direction. Accordingly, if the laser power becomes zero in such a period of time that expansion of a region on the light spot center having a temperature equal to or higher than the melting point due to heat conduction is negligible, the recrystallization ring is eventually limited to a very narrow range.

On the other hand, in the case of mark formation using the conventional recording pulse, since irradiation with relatively low power is performed for a long time, a region on the light spot center whose temperature exceeds the melting point gradually expands (from the upper stage to the middle stage in FIG. 12). At this time, the temperature distribution in section including the light spot center no longer takes Gaussian distribution and it forms a shape having a further gentle temperature gradient (the lower stage in FIG. 12).

Therefore, a region to be re-crystallized has a relatively large spreading in a plane direction. The broken line in the middle stage of FIG. 12 shows a recrystallization limit and a region surrounded by the broken line is a region forming the amorphous mark. Thus, in the conventional recording pulse, a large recrystallization ring is formed at the mark formation time.

It is thought that a width of the recrystallization ring in the plane direction is approximately equal to a diffusion distance of the melting point region in the plane direction in the pulse irradiation time. Assuming that a general phase-change material has heat conductivity K=0.005 J/cm/s/° C. and specific heat C=1.5 J/cm³/° C., a heat diffusion distance within the pulse irradiation time can be estimated. Since it is thought that heat diffuses for a time t by a distance L=(Kt/C)1/2, the region of the recrystallization ring is limited to a range of 10% or less of the shortest mark length of 0.204 μm of an HD DVD-RW disk. That is, the pulse irradiation time is set to 0.44 ns in order to limit the region of recrystallization ring to a range of 10.2 nm or less in one direction. This pulse irradiation time can be described as a pulse width required for mono-pulse recording.

As already described, since the Equation (2) is obtained as the relationship between the resonator length L of the semiconductor laser and the relaxation oscillation pulse width Wr obtained, it has been found that it is necessary to use the pulse width of 440 ps or less, namely, the semiconductor laser having the resonator length of 3520 μm or less for mono-pulse recording.

On the other hand, in view of reduction of the recrystallization ring, it is better that the pulse irradiation time is shorter, but the short time makes it difficult to provide the energy for raising the temperature of the phase-change material up to the melting point thereof, or higher, from a practical standpoint. That is, it is necessary to perform irradiation of an extremely high power over a short time. Accordingly, it can be thought that the pulse irradiation time must be set to about 50 ps or more in practice. This pulse irradiation time corresponds to necessity for a semiconductor laser having a resonator length of at least 400 μm in view of the relationship represented by Equation (2).

As understood from Equation (2), when the relaxation oscillation pulse is used for information recording on an optical disk, the relaxation oscillation pulse width is uniquely determined according to determination of the resonator length of a laser device LD used in the recording apparatus. As described above, when the pulse width is short, the temperature of the phase-change material can be raised up to the melting point thereof or higher by irradiation of high power, but such a case may occur that the temperature of the phase-change material does not reach the melting point or higher even if irradiation is performed with the maximum power of the laser device LD. In such a case, it is effective to perform irradiation of a relaxation oscillation pulse plural times.

If the drive pulse from the laser device LD is controlled such that the relaxation oscillation pulse is generated, for example, three times, it is made possible to raise the temperature of the phase-change material up to the melting point or higher by an increase of the irradiation energy (temporal integration value by pulse). However, intensities of the second and third relaxation oscillation pulses gradually lower as compared with the intensity of the first relaxation oscillation pulse. Therefore, the irradiation of a pulse more than the three times is not so effective.

In the recording apparatus which records data on an optical recording medium using a relaxation oscillation pulse of the laser device LD in this manner, it is necessary to increase or decrease the number of relaxation oscillation pulses according to the resonator length of the semiconductor laser. Even when laser from a semiconductor laser with a low rated output is utilized, it is effective to use relaxation oscillation pulse plural times.

Incidentally, the information recording medium according to the present invention comprises a recording layer made from a phase-change material, an optical interference layer made from a dielectric, and a reflecting layer made from a metal. SbTe series, InSB series, or GaSb series, which are eutectic compounds having fast crystal growth rates, are suitable for the recording layer. An optical contrast or recording characteristic can be further improved by adding Ge, In, Co, Ag, or the like to the eutectic compound in an appropriate amount. A composite compound comprising one of ZnS, SiO₂, Al₂O₃, Si₃N₄, ZrO₂, AlN, Cr₂O₃, GeN, Ta₂O₅, and Nb₂O₅ is suitable for the optical interference layer used for increasing reflectance change before and after recording or for protecting the recording layer mechanically or thermally. The optical interference layer achieves optical enhancement and serves to reduce stress on the recording layer, or control the temperature rise due to laser irradiation. Two or more optical interference layers may be configured in order to achieve these objects. The reflecting layer including Al, Ag, or Au as a main component is provided in order to obtain reflection light at the reproducing time or perform temperature control in response to beam irradiation at the recording time.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information recording apparatus for recording data comprising a laser drive circuit configured to supply a drive current to a laser device, and a controller configured to control the drive current from the laser drive circuit in response to a write strategy, wherein the recording is performed using laser light generated by a relaxation oscillation of the laser device.

2. The information recording apparatus of claim 1, wherein
the controller comprises means for selectively controlling a first drive current in order to generate a plurality of pulse laser lights with the relaxation oscillation for a first mark formation, and a second drive current in order to generate a laser light where laser pulses are combined for a second mark formation,
wherein an intensity of the laser light comprises an onset of an abrupt impulse change at an onset caused by the relaxation oscillation and wherein the intensity is substantially constant during a period between the onset and an offset.

3. The information recording apparatus of claim 1, wherein
the controller is configured to set an interval of a current from the laser drive circuit to the laser device to the drive circuit when a sum of an interval of the current in the laser device and a current offset time of the laser device is equal to or greater than 4.5 ns when a plurality of the laser lights is used.

4. The information recording apparatus of claim 1, wherein
the laser drive circuit comprises a plurality of current sources, and the laser drive circuit is configured to synthesize outputs of a plurality of the current sources into a synthesized output, and to output the synthesized output,
the current sources comprise a first current source outputting a first current with a rectangular wave to the laser device for outputting a laser light with the relaxation oscillation, a second drive current source outputting a pulse-shaped second current for emphasizing an offset level of the first current, and a third current source outputting a third current having an amount of the third current equal to or smaller than a threshold value when the laser device causes oscillation, and the laser drive circuit is configured to synthesize the first, second and third currents and to output the synthesized currents; and
the controller comprises means for selectively controlling the first, second and third current sources, and is configured to selectively control a first drive current in order to generate a plurality of pulse laser lights with the relaxation oscillation for a first mark formation, and a second drive current in order to generate a laser light where laser pulses are combined for a second mark formation,
wherein an intensity of the laser light comprises an onset of an abrupt impulse change caused by the relaxation oscillation and wherein the intensity is substantially constant during a period between the onset and an offset.

5. The information recording apparatus of claim 1, wherein
the controller and the drive circuit are configured to synthesize the first and third currents in order to output the first drive current, and to synthesize the first, second and third currents in order to output the second drive current.

6. A control method of an information recording apparatus comprising a laser drive circuit configured to supply a drive current to a laser device, a controller configured to control the drive current from the laser drive circuit in response to a write strategy, comprising
controlling a plurality of current sources in the laser drive circuit; and
selectively outputting and controlling a first drive current in order to generate a plurality of pulse laser lights with a relaxation oscillation for a first mark formation, and a second drive current in order to generate a laser light where laser pulses are combined for a second mark formation,
wherein an intensity of the laser light comprises an onset of an abrupt impulse change caused by the relaxation oscillation and wherein the intensity is substantially constant during a period between the onset and an offset.

7. The control method of an information recording apparatus of claim 6, comprising:
outputting the first drive current when a sum of a current offset time of the laser device and an interval of a plurality of a mono-pulse laser lights with the relaxation oscillation is equal to or greater than 4.5 ns; and
outputting the second drive current when the sum is smaller than 4.5 ns.

8. The control method of an information recording apparatus of claim 6, comprising:
outputting the second drive current when high-speed recording is performed.
